(19) United States
(12) Patent Application Publication
(10) Pub. No.: US 2006/0117994 A1
(43) Pub. Date: Jun. 8, 2006

(54) Ink composition

(76) Inventors: Seung-min Ryu, Yongin-si (KR); Jong-in Lee, Suwon-si (KR)

Correspondence Address: STANZIONE & KIM, LLP, 919 18TH STREET, N.W., SUITE 440, WASHINGTON, DC, 20006, US

(21) Appl. No.: 11/272,132

(22) Filed: Nov. 14, 2005

(30) Foreign Application Priority Data
Nov. 12, 2004 (KR) 10-2004-0092333

(51) Int. Cl. C09D 11/00

(52) U.S. Cl. 106/31.58; 106/31.86; 106/31.43; 106/31.75; 106/31.46; 106/31.47; 106/31.49; 106/31.76; 106/31.77; 106/31.78

(57) ABSTRACT

An ink composition including a colorant, a solvent, and a surface property treatment agent represented by the following formula (1): 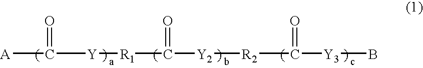 where each of Y1, Y2, and Y3 is independently —N(R3)- or —O—. R3 is H, a C1-C20 alkyl group, or a C6-C20 aryl group, each of R1 and R2 is independently a chemical bond, a C1-C10 alkylene group, a C2-C10 alkenylene group, a C2-C10 alkynylene group, or a C1-C20 alkyl group including a C2-C10 alkenylene group or a C2-C10 alkynylene group, 1≦a≦7, and b, c≧0 are integers, each of A and B is a hydrophobic moiety or are connected to each other to form a ring, A and B cannot simultaneously be H, and B can be a hetero atom. The ink composition can reduce smearing by increasing the rate of penetration into paper and may increase a duration of storage stability, while using little or no surfactant.

### CROSS-REFERENCE TO RELATED APPLICATIONS

This application claims the benefit of Korean Patent Application No. 10-2004-0092333, filed on Nov. 12, 2004, in the Korean Intellectual Property Office, the entire contents of which is incorporated herein by reference.

### BACKGROUND OF THE INVENTION

1. Field of the Invention

The present general inventive concept relates to an ink composition, and more particularly, to an ink composition which contains an amide-based or ester-based compound to optimize the surface tension of an ink and to lessen the amount of smearing and increase the duration of storage stability. The ink composition uses little or no surfactant.

2. Description of the Related Art

Printing methods performed by printers are broadly divided into non-impact printing methods and impact printing methods. Inkjet printing is a non-impact printing method that makes less noise than an impact printing method and can produce color images more easily than a laser beam printer.

Inkjet printing methods are divided into a continuous stream method and a drop-on-demand (DOD) method. In the continuous stream method, ink is continuously ejected from orifices or nozzles by pressure. The ejected ink is scattered while forming droplets at a predetermined distance from the orifices. When the droplets are dispersed, they are electrically charged according to digital data signals. That is, when the droplets pass through an electric field, the droplets are recirculated or directed toward a gutter at a predetermined position of a recording medium. In the DOD method, droplets are ejected on a target position of a recording medium from orifices according to digital data signals.

The DOD method does not require ink recovery, charging, or deflection, thus the DOD method is simpler to implement than the continuous stream method. The DOD method is divided into a thermal inkjet (also referred to as bubble jet) method and a piezoelectric inkjet method.

In the thermal inkjet method, ink is ejected by pressure produced from the expansion of bubbles caused by heating. In this case, droplets are produced rapidly and a high density of nozzles may be used. The thermal inkjet method can be used to provide a printer that is simpler, cheaper, and faster than a printer using the continuous stream method.

On the other hand, in the piezoelectric inkjet method, ink is ejected by pressure generated using a piezoelectric plate that mechanically charges droplets using electricity. In the piezoelectric inkjet method, a relatively large-sized piezoelectric plate interferes with a high density of nozzles and such a physical limitation of the piezoelectric plate results in a reduction in the speed of producing ink droplets. Such a slow droplet speed significantly reduces resistance to a change in droplet speed, which degrades printing quality. The piezoelectric inkjet method also has the disadvantage of a slow printing speed.

Recent inkjet printers have produced smaller dot sizes and high quality prints as higher resolutions become required. In order to obtain a smaller dot size, a head of an inkjet printer is constructed with smaller nozzle openings. Such a nozzle opening easily clogs and the efficient ejection of inkjet droplet ejections. It is well established that ink composition affects the likelihood of nozzle clogging. To reduce nozzle clogging, a wetting agent is commonly added to an ink composition for an inkjet printer.

A basic ink composition for an inkjet printer is composed of a colorant, a solvent, and an additive. A surfactant is generally used as the additive to provide the ink composition with proper viscosity and surface tension when used in an ink jet printer.

Generally, the surfactant is composed of a hydrophobic group and a hydrophilic group, and dissolves well in water. The surface tension of ink is adjusted to a desired range to optimize the wetness level of the ink on a hydrophobic colorant surface. Thus, the adjustment of the surface tension of the ink contributes to the formation of ink droplets of desired sizes in printer head nozzles to provide a stable discharge.

Examples of the use of such a surfactant include a method using an amine-based surfactant (U.S. Pat. No. 5,562,762), a method using a surfactant including a mixture of quaternary ammonium chloride and alkoxylated ether (U.S. Pat. No. 5,833,744), and a method using a mixture of a silicon-based surfactant and a fluorine-based surfactant (U.S. Pat. No. 5,852,075).

Among known surfactants, ionic surfactants, such as anionic and cationic surfactants are composed of a hydrophobic group, such as a long carbon chain, a polymer structure or an aryl group, and an ionic hydrophilic group, as represented by the following formula (2). Thus, ionic surfactants have good miscibility with water. However, ionic surfactants cause agglomeration and phase separation of ink due to charge-charge interactions between cations (or anions) of a colorant and anions (or cations) of the surfactant in an ink chamber, and clogging of ink in a nozzle surface. Thus, long-term storage stability of ink and long-term use of a cartridge are reduced.

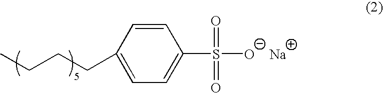

To solve these problems, nonionic surfactants composed of a nonionic hydrophilic group and a polymer hydrophobic group have been used recently. When ink including the nonionic surfactant is left for a long period without use, the long polymer hydrophobic group of the surfactant in the ink accelerates drying of the ink in air. Once the ink is dried, the viscosity is rapidly increased by the polymer hydrophobic group, which causes nozzle clogging. The hardened ink cannot be removed by spitting or wiping, which is a general maintenance method of printers. Thus, the ink can be used no longer.

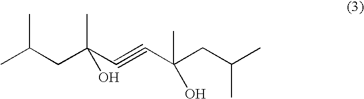

### SUMMARY OF THE INVENTION

The present general inventive concept provides an ink composition using little or no surfactant in the composition. The penetration of the ink into the paper may be optimized to reduce the amount of smearing.

Additional aspects and advantages of the present general inventive concept will be set forth in part in the description which follows and, in part, will be obvious from the description, or may be learned by practice of the general inventive concept.

The foregoing and/or other aspects of the present general inventive concept are achieved by providing an ink composition including, for example, a colorant, a solvent, and a surface property treatment agent represented by the following formula (1):

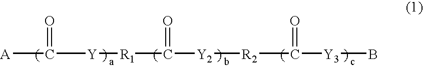

where each of Y₁, Y₂, and Y₃ is independently —N(R₃)— or —O—;

where R₃ is H, a C1-C20 alkyl group, or a C6-C20 aryl group;

each of R₁ and R₂ is independently a chemical bond, a C1-C10 alkylene group, a C2-C10 alkenylene group, a C2-C10 alkynylene group, or a C1-C20 alkyl group including a C2-C10 alkenylene group or a C2-C10 alkynylene group;

where 1≦a≦7, and b, c≧0 are integers;

each of A and B are a hydrophobic moiety independently selected from the group consisting of a substituted or unsubstituted C1-C12 alkyl group, a substituted or unsubstituted C2-C12 alkenyl group, a substituted or unsubstituted C2-C12 alkynyl group, and a substituted or unsubstituted C6-C12 aryl group, or are connected to each other to form a ring;

both A and B cannot be H; and

B can be a hetero atom.

The foregoing and/or other aspects of the present general inventive concept may also be achieved by providing an ink composition including a colorant, a solvent, a surfactant, and a nonionic surface property treatment agent represented by the following formula (1):

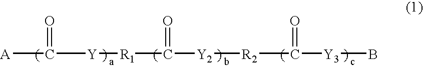

where each of Y₁, Y₂, and Y₃ is independently —N(R₃)— or —O—;

where R₃ is H, a C1-C20 alkyl group, or a C6-C20 aryl group;

each of R₁ and R₂ is independently a chemical bond, a C1-C10 alkylene group, a C2-C10 alkenylene group, a C2-C10 alkynylene group, or a C1-C20 alkyl group including a C2-C10 alkenylene group or a C2-C10 alkynylene group;

where 1≦a≦7, and b, c≧0 are integers;

each of A and B are a hydrophobic moiety independently selected from the group consisting of a substituted or unsubstituted C1-C12 alkyl group, a substituted or unsubstituted C2-C12 alkenyl group, a substituted or unsubstituted C2-C12 alkynyl group, and a substituted or unsubstituted C6-C12 aryl group, or are connected to each other to form a ring;

both A and B cannot be H; and

B can be a hetero atom.

The foregoing and/or other aspects of the present general inventive concept may also be achieved by providing an ink having a surfactant-free composition including a colorant, a solvent, and a surface property treatment agent, the ink composition comprising 0.01-20 parts by weight of the surface property treatment agent based on 100 parts by weight of the solvent and the colorant; 0.5-10 parts by weight of the colorant based on 100 parts by weight of the solvent and the surface property agent; 40-95 parts by weight of the solvent based on 100 parts by weight of the colorant and the surface property treatment agent.

The foregoing and/or other aspects of the present general inventive concept may also be achieved by providing a method of preparing an ink composition comprising combining a colorant, a surface property treatment agent, and a solvent, wherein the surface property treatment agent represents 0.01-20 parts by weight based on 100 parts by weight of the solvent and the colorant, the colorant represents 0.5-10 parts by weight based on 100 parts by weight of the solvent and the surface property agent, and the solvent represents 40-95 parts by weight based on 100 parts by weight of both the colorant and the surface property treatment agent; mixing the combination; and filtering the combination to obtain the ink composition.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIGS. 1 and 2 illustrate the results of evaluating initial dryness of an ink composition prepared according to an embodiment of the general inventive concept; and

FIG. 3 is a graph illustrating initial drying time vs. surfactant concentration for an ink composition prepared according to an embodiment of the general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

An ink composition including an amide-based or ester-based compound according to embodiments of the present general inventive concept can be used in the fields of, for example, pigments, paints, inks, and the like, but will likely be primarily used for a printer, and in particular, an inkjet printer. Therefore, an ink composition for an inkjet printer will be specifically described.

The ink composition according to various exemplary embodiments of the present general inventive concept includes a surface property treatment agent represented by the above formula (1). The surface property treatment agent has a non-ionic structure, is not a polymer which causes drying of a nozzle surface and clogging, is composed of a hydrophobic moiety and a hydrophilic moiety, and has polarity due to delocalization of electrons. Thus, the surface property treatment agent acts as a potential surface property treatment agent capable of adjusting the surface properties of ink.

In formula (1), both A and B cannot be H, and B can be a hetero atom.

In formula (1), each of A and B may independently be a C1-C12 alkyl group, a C1-C12 heteroalkyl group, a C2-C12 alkenyl group, a C2-C12 heteroalkenyl group, a C2-C12 alkynyl group, a C6-C20 aryl group, a hydroxy group, a thiol group, a halogen atom, a nitro group, a cyano group, an isocyano group, an ester group, an amino group, a carboxylic group, or the like, but are not limited thereto. When A and B are connected to each other to form a ring, the ring may be a substituted or unsubstituted C4-C20 carbocycle, a substituted or unsubstituted C2-C20 heterocycle, or a C6-C20 aromatic ring (for example, benzene, naphthalene, etc.).

The surface property treatment agent represented by formula (1) is composed of a single molecular hydrophobic group and one or more hydrophilic groups.

Examples of the surface property treatment agent represented by formula (1) include amide-based and ester-based compounds represented by formulae (4) to (11): 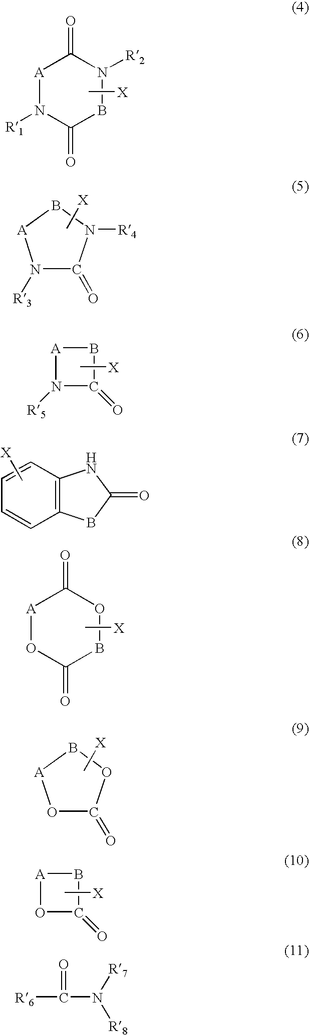
where each of R1′, R2′, R3′, R4′, R5′, R6′, R7′, and R8′ is independently H, a substituted or unsubstituted C1-C20 alkyl group, a substituted or unsubstituted C1-C20 heteroalkyl group, a substituted or unsubstituted C2-C20 alkenyl group, a substituted or unsubstituted C1-C20 alkoxy group, a substituted or unsubstituted C1-C20 alkylsulfoneamide group, a substituted or unsubstituted C6-C20 arylsulfoneamide group, a substituted or unsubstituted C1-C20 acylamino group, a C1-C20 alkylureido group, a C6-C20 arylureido group, a C2-C20 alkoxycarbonyl group, a C2-C20 alkoxycarbonylamino group, a carbamoyl group, a sulfamoyl group, a sulfo group and a salt thereof, a carboxy group and a salt thereof, a substituted or unsubstituted C1-C20 hydroxyalkyloxyalkyl group, a substituted or unsubstituted C1-C20 dialkylaminoalkyl group, a substituted or unsubstituted C6-C20 pyridylalkyl group, a substituted or unsubstituted C5-C20 pyridyl group, a substituted or unsubstituted C6-C20 imidazolyl group, a hydrazine group, a hydrazone group, a substituted or unsubstituted C1-C20 pyridylalkyl group, a substituted or unsubstituted C6-C20 aryl group, a substituted or unsubstituted C6-C20 arylalkyl group, a substituted or unsubstituted C6-C20 heteroaryl group, a substituted or unsubstituted C6-C20 heteroarylalkyl group, a substituted or unsubstituted C3-C20 heteroarylalkenyl group, or a substituted or unsubstituted C3-C20 heterocycloalkyl group;

A is a simple chemical bond, or —C≡C—, —CH=CH—, —CmH2m-, or —CH— of an aryl group;

B is a simple chemical bond, or —C≡C—, —CH═CH—, —CnH2n-, or —CH— of an aryl group;

m and n are each an integer from 0 to 10 and satisfy the following Equation 1:
2≦m+n≦10 (1)

therefore, if m=0, 2≦n≦10, and if n=0, 2≦m≦10; and

X may be a monosubstituted or polysubstituted substituent and is H, a substituted or unsubstituted C1-C20 alkyl group, a substituted or unsubstituted C1-C20 heteroalkyl group, a substituted or unsubstituted C2-C20 alkenyl group, a substituted or unsubstituted C1-C20 alkoxy group, a substituted or unsubstituted C1-C20 alkylsulfoneamide group, a substituted or unsubstituted C6-C20 arylsulfoneamide group, a substituted or unsubstituted C1-C20 acylamino group, a C1-C20 alkylureido group, a C6-C20 arylureido group, a C2-C20 alkoxycarbonyl group, a C2-C20 alkoxycarbonylamino group, a carbamoyl group, a sulfamoyl group, a sulfo group and a salt thereof, a carboxy group and a salt thereof, a substituted or unsubstituted C1-C20 hydroxyalkyloxyalkyl group, a substituted or unsubstituted C1-C20 dialkylaminoalkyl group, a substituted or unsubstituted C6-C20 pyridylalkyl group, a substituted or unsubstituted C5-C20 pyridyl group, a substituted or unsubstituted C6-C20 imidazolyl group, a hydrazine group, a hydrazone group, a substituted or unsubstituted C1-C20 pyridylalkyl group, a substituted or unsubstituted C6-C20 aryl group, a substituted or unsubstituted C6-C20 arylalkyl group, a substituted or unsubstituted C6-C20 heteroaryl group, a C6-C20 heteroarylalkyl group, a substituted or unsubstituted C6-C20 heteroarylalkenyl group, or a substituted or unsubstituted C3-C20 heterocycloalkyl group.

R1 and R2 can each be independently H or a methyl group and each of A and B can be independently —C≡C—, —CH═CH—, —CH2CH2-, —CH2-, —CH(CH3)-, or —CH— of an aryl group, not H.

When X is a polysubstituted substituent, 1 to 16 Xs may be included in the formula (1).

When the compound represented by formula (1) is a cyclic compound having 16 atoms or more, its stability is reduced due to a ring being too large. A cyclic compound having 14 atoms or less is preferable and a cyclic compound having 4 to 10 atoms is more preferable.

Specific examples of the amide-based compounds represented by formulae (4) to (11) include 2-azacyclooctanone represented by formula (12), glycine anhydride represented by formula (13), uracil represented by formula (14), hydantoin represented by formula (15), N-methyl pyrrolidone (NMP) represented by formula (16), 2-pyrrolidone represented by formula (17), 3,6-dimethyl-1,4-dioxane-2,5-dione represented by formula (18), ethylene carbonate represented by formula (19), γ-butyrolactone represented by formula (20), oxindole represented by formula (21), and stearamide represented by formula (22), but are not limited thereto.

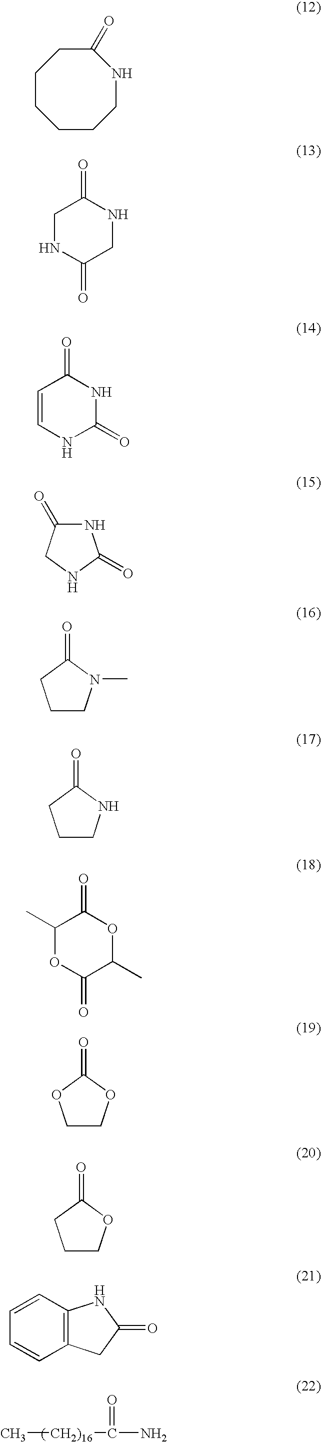

How the amide-based and ester-based compounds, which are surface property treatment agents according to embodiments of the present general inventive concept, improve the surface properties of ink will now be described.

The amide-based and ester-based compounds can have resonance structures represented by formulae (23) and (24) and have strong polarities, whereby they are easily charged.

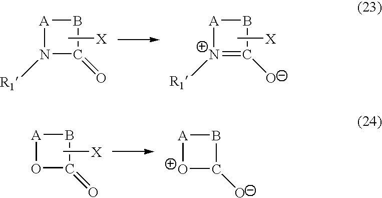

As is apparent from the above formulae (23) and (24), the amide-based and ester-based compounds have an anionic property at a single-bonded oxygen atom and a cationic property at a nitrogen or oxygen atom in a ring. The ionic groups are hydrophilic, but the A-B portion in the ring is hydrophobic and interferes with hydrogen bonding of water in an aqueous ink composition. Thus, the surface tension is lowered and the wettability of the surface of a hydrophobic colorant is improved. The resonance structure formed between nitrogen or oxygen in the ring and the carbonyl group maintains the hydrophilic-hydrophobic balance of ink even in an environment where physical properties of the ink can be changed due to the contamination of a foreign substance or a change of external temperature, thereby maintaining the fluidity of the ink when used in a printer head. In addition, the ink supply is sufficient and stable, and thus a larger ink drop size can be produced. Furthermore, ink drops formed in this way maintain their sizes even when used for a long period of time and may uniformly maintain their desired ejection directions.

The ink composition including one of the amide-based or ester-based compounds described above can be used in inkjet ink, in printing ink, in paint, for textile printing, for paper manufacturing, in cosmetics, in ceramics, and in other related uses and compositions.

The ink composition according to embodiments of the present general inventive concept contains 0.01-20 parts by weight of the surface property treatment agent represented by formula (1) based on 100 parts by weight of a solvent. When the amount of the surface property treatment agent represented by formula (1) is less than 0.01 part by weight, the affects described above are indiscernible. When the amount of the surface property treatment agent is greater than 20 parts by weight, the solubility thereof in an aqueous solution is reduced.

A colorant included in the ink composition according to embodiments of the present general inventive concept may be a dye or pigment. A self-dispersing pigment, which does not require a separate dispersant, can be used as the colorant. The amount of the colorant is preferably 0.5-10 parts by weight based on 100 parts by weight of a solvent. When the amount of the colorant is less than 0.5 parts by weight, color formation is difficult due to low color density. When the amount of the colorant is greater than 10 parts by weight, the duration of storage stability is reduced due to nozzle clogging and similar problems.

An aqueous liquid medium or a mixture of an aqueous liquid medium and an organic solvent is used as the solvent.

The ink composition according to embodiments of the present general inventive concept is a surfactant-free composition and has a surface tension of 20-65 dyne/cm at 20° C. and has a viscosity of 1-10 cps. When the optical density of an initial image printed on general paper is denoted OD1 and the optical density of the initial image when mounting 50 sheets of general paper on the printed paper immediately after printing and removing the mounted papers after 10 sec is denoted OD2, then OD2 is greater than 50% of OD1, and even greater than 65% of OD1.

When the surface tension of the ink composition at 20° C. is less than 20 dyne/cm, the penetration of ink into paper may occur too fast, resulting in a loss of color formation due to color density reduction. When the surface tension of the ink composition is greater than 65 dyne/cm, the penetration of ink into paper may occur too slow, thus increasing the chances of smearing. When the viscosity of the ink composition is less than 1 cps, the ink may be too diluted, thus ink droplets may not be jetted properly due to bubble formation, or, even when jetted, the desired color density cannot be obtained since dots are too small and the ink penetrates into the paper too quickly. Alternatively, when the viscosity is greater than 10 cps, the fluidity may be too low.

An ink composition for inkjet printers including one of the amide-based or ester-based compounds as a surface property treatment agent will now be described in detail. The following description is only an example of an ink composition for an inkjet printer including one of the amide-based or ester-based compounds, and is not intended to limit the scope of the present general inventive concept.

The ink composition of the present embodiment includes an aqueous liquid medium as a solvent. The aqueous liquid medium may be water or a mixture of water and one or more organic solvents. The total amount of solvents in the ink composition is preferably 40-95 parts by weight based on 100 parts by weight of both the colorant and the surface property treatment agent in the ink composition.

The total amount of organic solvents is preferably 2-60 parts by weight based on 100 parts by weight of all of the solvents. When an organic solvent is used with water, the viscosity and surface tension of the ink composition can be adjusted in proper ranges.

The type of organic solvent is not particularly restricted. Examples of the organic solvent that can be used include alcohols such as methylalcohol, ethylalcohol, n-propylalcohol, isopropylalcohol, n-butylalcohol, sec-butylalcohol, t-butylalcohol, isobutylalcohol, etc.; ketones such as acetone, methylethylketone, diacetonealcohol, etc.; esters such as ethyl acetate, ethyl lactate, etc.; polyhydric alcohols such as ethyleneglycol, diethyleneglycol, triethyleneglycol, propyleneglycol, butyleneglycol, 1,4-butanediol, 1,2,4-butanetriol, 1,5-pentanediol, 1,2,6-hexanetriol, hexyleneglycol, glycerol, glycerol ethoxylate, trimethylolpropane ethoxylate, etc.; lower alkyl ethers such as ethyleneglycol monomethyl ether, ethyleneglycol monoethyl ether, diethyleneglycol methyl ether, diethyleneglycol ethyl ether, triethyleneglycol monomethyl ether, triethyleneglycol monoethyl ether, etc.; nitrogen-containing compounds such as 2-pyrrolidone, N-methyl-2-pyrrolidone, etc; and sulfur-containing compounds such as dimethyl sulfoxide, tetramethylenesulfone, thioglycol, etc.

The ink composition of the present embodiment can further include a surfactant, if necessary. The surfactant can adjust the surface tension of the ink composition to stabilize the jetting performance in inkjet nozzles. The amount of the surfactant is 0.005-3.0 parts by weight based on 100 parts by weight of a solvent.

When the amount of the surfactant is less than 0.005 parts by weight, the effect of the addition thereof may be insignificant. When the amount of the surfactant is greater than 3.0 parts by weight, drying of ink on the nozzle surface can increase while the viscosity of the ink rapidly increases, thus clogging the nozzle(s) and complicating the ejection of ink droplets therefrom.

Examples of the surfactant may include, for example, Acetylene Glycol series from Air Product, Tergitol from Union carbide chemical, Saccharide polyethylene oxide from ICI, and Disperbyk series from BYK, but are not limited thereto.

The ink composition containing the surfactant may have a surface tension of 15-65 dyne/cm at 20° C., and a viscosity of 1.5-10 cps. When the optical density of an initial image printed on general paper is denoted as OD1 and the optical density of the initial image when mounting 50 sheets of general paper on the printed paper immediately after printing and removing the mounted papers after 10 sec is denoted as OD2, OD2 is greater than 50% of OD1, and can be greater than 65% of OD1.

The ink composition may further include, if necessary, additives, such as, for example, a dispersant, a viscosity modifier, a metal oxide, etc., if necessary.

The viscosity modifier can adjust the viscosity of the ink composition to provide smoother jetting of ink. The viscosity modifier may include at least one compound selected from polyvinylalcohol, casein, polyvinyl pyrrolidone, polyethylene glycol, polypropyleneglycol, polyethylenepropylene copolymer, and carboxymethylcellulose, but is not limited thereto. The amount of the viscosity modifier may be 0.01-10 parts by weight with respect to 100 parts by weight of the solvent.

The ink composition of the present embodiment may further include an acid or base. The acid or base increases the solubility of a wetting agent in the solvent and stabilizes the colorant. The amount of the acid or base is preferably 0.1-20 parts by weight based on 100 parts by weight of the solvent.

The ink composition of the present embodiment may further include a dispersant. Examples of the dispersant which may be used in the preparation of the ink composition of the present embodiment may include a styrene methylacrylate-acrylic acid copolymer, butyl methacrylate-methacrylic acid copolymer, SMA (Styrene Maleic Anhydride), acryl (Johncryl 61, 62), and a sodium salt of naphthalene sulfonic acid-formalin condensation product (Demol N, available from Kao Co.). The amount of the dispersant is preferably 0.1-10 parts by weight based on 100 parts by weight of the solvent.

A method of preparing the ink composition described above will now be described.

First, a colorant, a surface property treatment agent represented by formula (1), and a wetting agent are added to a solvent and mixed. The mixture is homogenized by thoroughly stirring. Thereafter, the resultant is filtered to obtain the ink composition of the present general inventive concept.

In the above formulae, examples of unsubstituted C1-C20 alkyl group include methyl, ethyl, propyl, isobutyl, sec-butyl, pentyl, iso-amyl, hexyl, etc. At least one hydrogen atom in the alkyl group may be substituted with a halogen atom, a hydroxyl group, a nitro group, a cyano group, an amino group, an amidino group, hydrazine, hydrazone, carboxylic group or a salt thereof, a sulfonic acid group or a salt thereof, phosphoric acid or a salt thereof, a C1-C20 alkyl group, a C2-C20 alkenyl group, a C2-C20 alkynyl group, a C1-C20 heteroalkyl group, a C6-C20 aryl group, a C6-C20 arylalkyl group, a C6-C20 heteroaryl group, or a C6-C20 heteroarylalkyl group.

The heteroalkyl group is the alkyl group defined above containing nitrogen, sulfur, oxygen or a phosphorus atom. Examples of the heteroalkyl group include methoxy, ethoxy, propoxy, butoxy, and t-butoxy. Examples of the substituted heteroalkyl group include haroalkoxy radicals, such as fluoromethoxy, chloromethoxy, trifluoromethoxy, trifluoroethoxy, fluoroethoxy, and fluoropropoxy. At least one hydrogen atom in the heteroalkyl group may be substituted with substituents mentioned in connection with the above alkyl group.

The unsubstituted C2-C20 alkenyl group is the alkyl group defined above containing a carbon double bond in its spine or at a terminal. Examples of such an alkenyl group include ethylene, propylene, butylenes, hexylene, etc. At least one hydrogen atom in the alkenyl group may be substituted with substituents mentioned in connection with the above alkyl group.

The aryl group is a C6-C20 carbocyclic aromatic system containing one or more rings alone or in a combination, in which the rings may be attached to each other or fused by a pendant method. The aryl is an aromatic radical, such as phenyl, naphtyl, or tetrahydronaphtyl. The aryl group can be substituted with haloalkylene, nitro, cyano, alkoxy, or a lower alkylamino. At least one hydrogen atom in the aryl group may be substituted with the substituents mentioned in connection with the above alkyl group.

The arylalkyl group is the aryl group as defined above in which some of the hydrogen atoms are substituted with a low alkyl, such as methyl, ethyl, propyl, etc. Examples of such an arylalkyl group include benzyl and phenylethyl. At least one hydrogen atom in the arylalkyl group may be substituted with the substituents mentioned in connection with the above alkyl group.

The heteroaryl group is a monohydric monocyclic or dihydric bicyclic aromatic C1-C20 organic group containing 1, 2, or 3 hetero atoms selected from N, O, P and S. At least one hydrogen atom in the heteroaryl group may be substituted with the substituents mentioned in connection with the above alkyl group.

The heteroarylalkyl group is a heteroaryl group in which some of the hydrogen atoms are substituted by an alkyl group. At least one hydrogen atom in the heteroarylalkyl group may be substituted with the substituents mentioned in connection with the above alkyl group.

The present general inventive concept will now be described in greater detail with reference to the following examples. The following examples are for illustrative purposes only and are not intended to limit the scope of the general inventive concept.

### EXAMPLES

Dyes, pigments, and self dispersing pigments among colorants used in the following example are as follows.

<Dye>

Dye-C 1: Basacid Blue 762, BASF

Dye-C 2: IJ Blue 319H, Daiwa

Dye-M 1: SM-1, Nippon

Dye-M 2: Red AJ, Chugai

Dye-Y 1: Yellow GGN, Spectra

Dye-Y 2: Water Yellow 6, Orient Chemical

Dye-Bk 1: Schwarz SP, Bayer

Dye-Bk 2: Direc Bk HEF, Clariant

<Self-dispersing pigment>

S-Pigment 1: Cabot 200, Cabot (Bk)

S-Pigment 2: IJX-253, Cabot (Cyan)

S-Pigment 3: IJX-266, Cabot (Magenta)

S-Pigment 4: IJX-444, Cabot (Yellow)

<Pigment>

Pigment 1: Raven 5250, Columbian

Pigment 2: Furnace Black 101, Degussa

Pigment 3: Heliogen blue D 7080, BASF (Cyan)

Pigment 4: Quindo magenta RV-6832, Bayer (Magenta)

Pigment 5: Sicopal Yellow L 1100, BASF (Yellow)

The pigments are applied as dispersions prepared as follows.

Dispersion 1

2.0 g of a styrene methylacrylate-acrylic acid copolymer as a dispersant are dissolved in 20 g of water and 4.0 g of Pigment-1 is added thereto. Then, the result is premixed at 500 rpm for 1 hour and stirred in a Dipermat dispersing machine (bead size 0.3 mm) at 10,000 rpm for 2 hours. Thereafter, the resultant is filtered through a glass filter having a pore size of 2 μm to obtain dispersion 1.

Dispersion 2

A dispersion is prepared in the same manner as dispersion 1, except that 2.5 g of a butyl methacrylate-methacrylic acid copolymer and 5.0 g of Pigment-2 are used instead of 2.0 g of the styrene methylacrylate-acrylic acid copolymer and 4.0 g of Pigment-1.

Dispersion 3

A dispersion is prepared in the same manner as dispersion 1, except that 5.0 g of an ethyl hexyl methacrylate-methacrylic acid copolymer and 7.0 g of Pigment-3 are used instead of 2.0 g of the styrene methylacrylate-acrylic acid copolymer and 4.0 g of Pigment-1.

Dispersion 4

A dispersion is prepared in the same manner as dispersion 1, except that 5.5 g of a styrene maleic anhydride (SMA) and 8.2 g of Pigment-4 are used instead of 2.0 g of the styrene methylacrylate-acrylic acid copolymer and 4.0 g of Pigment-1.

Dispersion 5

A dispersion is prepared in the same manner as dispersion 1, except that 2 g of Johncryl-61 and 4.0 g of Pigment-5 are used instead of 2.0 g of the styrene methylacrylate-acrylic acid copolymer and 4.0 g of Pigment-1. Below is a list of a variety of different surfactants that are used in this dispersion 5.

<Surfactant>

Surfactant 1: Disperbyk-181, BYK

Surfactant 2: Disperbyk-183, BYK

Surfactant 3: Surfynol 465, Air Product

Surfactant 4: Surfynol 104, Air Product

Surfactant 5: Polyoxyethylene (20) sorbitan monosterarate (ICI)

Ink samples are prepared using a combination of the above dyes, self-dispersing pigments, dispersions, and in some cases surfactants.

A colorant, a surfactant or a surface property treatment agent, a moisture absorbent and an auxiliary solvent are added to a 250 mL beaker to form the compositions indicated in Table 1, and then water is added thereto to form a liquid with a total mass of 100 g. Thereafter, the mixture is homogenized by stirring at 700 rpm for 30 min or more and filtered through a 0.45 μm filter paper to obtain a final ink composition.

TABLE 1

| | | | | Property | | |
|---|---|---|---|---|---|---|
| | | | | treatment agent | | |
| | Colorant | Surfactant A | Surfactant B | A | Property | |
| | (Parts by | (Parts by | (Parts by | (Parts by | treatment agent B | Moisture absorbent |
| Sample | weight) | weight) | weight) | weight) | (Parts by weight) | (Parts by weight) |
| Example 1 | Dye-C1, (4) | X | X | Formula 22 (4) | Formula 20 (4) | 1,4-butanediol (12) |
| Example 2 | Dye-C2, (4) | Surfactant 3 (0.2) | X | Formula 17, (10) | x | 1,2-Hexanediol (6) |
| Example 3 | Dye-M1 (4) | X | X | Formula 13 (6) | Formula 15 (4) | 1,3-butanediol (14) |
| Example 4 | Dye-M2 (4) | Surfactant 5 (0.1) | Surfactant 1 (0.1) | Formula 16 (15) | | 1,4-butanediol (6) |
| Example 5 | Dye-Y1 (4) | x | X | Formula 12 (8) | Formula 14 (4) | 1,2-Hexanediol (10) |
| Example 6 | Dye-Y2 (4) | Surfactant 2 (0.2) | X | Formula 18, (18) | | hexylene glycol (7) |
| Example 7 | Dye-Bk1 (4) | X | X | Formula 19 (9) | Formula 12 (7) | 1,2,6-hexanetriol (14) |
| Example 8 | Dye-Bk2 (4) | x | Surfactant 4 (0.2) | Formula 20 (15) | | dipropylene glycol (13) |
| Example 9 | S-Pigment 1(4) | X | X | Formula 17 (8) | Formula 13 (4) | triethylene glycol (11) |
| Example 10 | S-Pigment 2 (4) | Surfactant 5 (0.1) | X | Formula 12 (7) | x | 1,3-butanediol (13) |
| Example 11 | S-Pigment 3 (4) | x | X | Formula 22 (5) | Formula 18 (8) | triethylene glycol (17) |
| Example 12 | S-Pigment 4 (4) | x | Surfactant 3 (0.1) | Formula 13 (8) | x | 1,3-butanediol (10) |
| Example 13 | Dispersion 1, (20) | x | X | Formula 17 (3) | Formula 13 (9) | 1,2-Hexanediol (11) |
| Example 14 | Dispersion 2 (16) | x | Surfactant 1 (0.3) | Formula 14 (3) | x | 1,4-butanediol (6) |
| Example 15 | Dispersion 3 (12) | x | X | Formula 16 (4) | Formula 19 (9) | 1,3-butanediol (11) |
| Example 16 | Dispersion 4, (10) | Surfactant 2 (0.1) | Surfactant 1 (0.2) | Formula 15 (7) | | 1,2-hexanediol (18) |
| Example 17 | Dispersion 5 (20) | Surfactant 4 (0.2) | Surfactant 5 (0.2) | Formula 18 (6) | x | 1,2,6-hexanetriol (18) |
| Comparative Example 1 | Dye-C1 (4) | Surfactant 3 (3.0) | X | X | x | dipropylene glycol (10) |
| Comparative Example 2 | Dye-Bk1 (4) | Surfactant 2 (2.0) | Surfactant 4 (2.0) | X | x | 1,4-butanediol (13) |
| Comparative Example 3 | Dispersion 1 (20) | Surfactant 1 (2.5) | Surfactant 5 (2.5) | X | x | 1,2-Hexanediol (12) |
| Comparative Example 4 | Dispersion 2 (16) | Surfactant 4 (2) | Surfactant 3 (4) | X | x | 1,3-butanediol (15) |
| Comparative Example 5 | Dispersion 3 (12) | Surfactant 5 (3) | Surfactant 2 (4) | Formula 15 (8) | x | 1,4-butanediol (11) |
| Comparative Example 6 | Dispersion 4 (10) | Surfactant 3 (4) | Surfactant 2 (5) | Formula 18 (4) | Formula 21 (3) | 1,2,6-hexanetriol (10) |

### Experimental Example 1

### Image Performance Evaluation

The ink compositions obtained in examples 1-17 and comparative examples 1-6 are filled into ink cartridges such as, for example, the M-50 (available from Samsung Electronics), and a dot pattern can be printed on premium inkjet paper (available from HP) in a printer such as, for example, an MJC-2400, available from Samsung Electronics. Then, the dot size, the dot size uniformity, and the production of satellites, which are small dots produced with a main dot, can be determined using an instrument such as (XC-003) available from imageXper, and the results that can be obtained are illustrated in Table 2.

A=dot size (diameter)

⊚: 75 μm<A

∘: 50 μm≦A≦75 μm

X: 25 μm≦A≦55 μm

XX: A<25 μm

B=Dot size uniformity

⊚: B<10 μm

∘: 10 μm≦B≦20 μm

X: 20 μm≦B≦30 μm

XX: 30 μm<B

C=Satellite

⊚: excellent

∘: acceptable

X: not acceptable

XX: worse

### Experimental Example 2

### Smear Evaluation

The ink compositions obtained in examples 1-17 and comparative examples 1-6 were filled in ink cartridges M-50 (available from Samsung Electronics) and a bar image (3 cm×20 cm) was printed with a printer (MJC-2400C, available from Samsung Electronics). The print was dried and the optical density (OD) thereof was measured and denoted as OD1. Immediately after a bar image (3 cm×20 cm) was printed on another piece of paper, 50 sheets of general paper were mounted on the print for approximately 10 sec and then removed. The OD of the print was measured and denoted as OD2. The ODs were compared (OD2 compared with OD 1) and the results are illustrated as percentages in Table 2.

D=Smearing=(OD2/OD1)×100 (%)

⊚: 70<D

∘: 50≦D≦70

X: 30≦D≦50

XX: D<30

### Experimental Example 3

### Storage Stability Evaluation

The ink compositions obtained in examples 1-17 and comparative examples 1-6 were filled in ink cartridges M-50 (available from Samsung Electronics) and stored for two weeks at different temperatures, for example, room temperature (25° C.), a low temperature (−18° C.), and a high temperature (38° C.). When printing was performed using these ink compositions (MJC-2400C, available from Samsung Electronics), it was determined how many nozzles were unable to discharge ink due to clogging. The results are illustrated in Table 2.
E=Storage stability=(total number of nozzles−number of clogged nozzles)/total number of nozzles×100 (%)

⊚: 90<E

∘: 70≦E≦90

X: 50≦E≦70

XX: E<50

### Experimental Example 4

### Initial Dryness Evaluation I (Latency Time Evaluation)

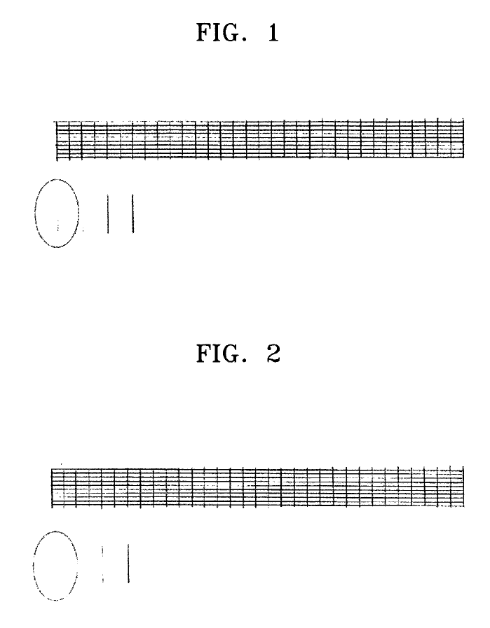

The ink compositions obtained in examples 1-17 and comparative examples 1-6 were filled in ink cartridges M-50 (available from Samsung Electronics), and a ladder pattern was printed, as illustrated in FIG. 1. After a predetermined latency time, printing was performed again. Dryness of ink on the nozzle surface according to latency time was evaluated and the results are illustrated in Table 2.

In FIG. 1, four vertical lines clearly appear below the ladder pattern, however, in FIG. 2, the two left most of the intended four vertical lines were not printed due to drying of ink that occurred during the latency time.

In the experiment, when all four vertical lines below the ladder pattern appeared as in FIG. 1, the experiment was performed again with an extended latency time. As a result, the left most of the four vertical lines did not clearly appear, as illustrated in FIG. 2, and thus were evaluated as N.G. The longest latency time was determined and recorded when all four vertical lines would appear.

Below is an account of the time in seconds for the measured latency time when four vertical lines were printed. F=initial dryness=Longest latency time when four vertical lines were printed.

⊚: 60 s<F

∘: 40 s≦F≦60 s

X: 20 s≦F≦40 s

XX: F<20 s

TABLE 2

| | Dot size | Dot sizeuniformity | Satellite | Smear | Storagestability | Initialdryness |
|---|---|---|---|---|---|---|
| Example 1 | ⊚ | ⊚ | ⊚ | ◯ | ⊚ | ◯ |
| Example 2 | ◯ | ⊚ | ◯ | ⊚ | ⊚ | ◯ |
| Example 3 | ⊚ | ◯ | ⊚ | ◯ | ⊚ | ⊚ |
| Example 4 | ◯ | ⊚ | ⊚ | ⊚ | ◯ | ◯ |
| Example 5 | ◯ | ◯ | ⊚ | ◯ | ⊚ | ⊚ |
| Example 6 | ⊚ | ◯ | ◯ | ⊚ | ⊚ | ⊚ |
| Example 7 | ◯ | ⊚ | ⊚ | ◯ | ⊚ | ◯ |
| Example 8 | ⊚ | ⊚ | ◯ | ⊚ | ◯ | ⊚ |
| Example 9 | ◯ | ◯ | ◯ | ⊚ | ⊚ | ◯ |
| Example 10 | ⊚ | ◯ | ⊚ | ⊚ | ⊚ | ◯ |
| Example 11 | ⊚ | ◯ | ◯ | ⊚ | ◯ | ⊚ |
| Example 12 | ◯ | ⊚ | ◯ | ⊚ | ⊚ | ◯ |
| Example 13 | ◯ | ◯ | ⊚ | ⊚ | ⊚ | ⊚ |
| Example 14 | ⊚ | ⊚ | ⊚ | ◯ | ◯ | ◯ |
| Example 15 | ◯ | ◯ | ◯ | ⊚ | ⊚ | ⊚ |
| Example 16 | ⊚ | ⊚ | ◯ | ⊚ | ◯ | ⊚ |
| Example 17 | ⊚ | ◯ | ⊚ | ◯ | ⊚ | ⊚ |
| ComparativeExample 1 | X | X | X | ◯ | X | X |
| ComparativeExample 2 | ⊚ | ◯ | ◯ | X | ◯ | XX |
| ComparativeExample 3 | XX | ◯ | ◯ | X | XX | X |
| ComparativeExample 4 | ◯ | XX | XX | ◯ | ◯ | ◯ |
| ComparativeExample 5 | X | X | ◯ | X | XX | XX |
| ComparativeExample 6 | ◯ | XX | XX | ◯ | X | X |

### Experimental Example 5

### Initial Dryness Evaluation II (Latency Time Evaluation)

An initial dryness evaluation for the surfactant content was performed in the same manner as in experimental example 4. Percentages 0, 1, 5 and 10% of the surfactants were added to 4% colorants in each ink composition, as indicated in Table 3. The results of the initial dryness evaluation are illustrated in Table 4.

TABLE 3

Surfactant content

| | 0% | 1% | 5% | 10% |
|---|---|---|---|---|
| Cyan | C1 | C2 | C3 | C4 |
| (IJ Blue 762, 4%) | | | | |
| Magenta | M1 | M2 | M3 | M4 |
| (SM-1, 4%) | | | | |
| Yellow | Y1 | Y2 | Y3 | Y4 |
| (Yellow GGN, 4%) | | | | |
| Black | B1 | B2 | B3 | B4 |
| (IJX-253, 4%) | | | | |

TABLE 4

Initial dryness (sec)

| | 0% | 1% | 5% | 10% |
|---|---|---|---|---|
| | surfactant | surfactant | surfactant | surfactant |
| Cyan | 240 | 120 | 10 | 0 |
| Magenta | 80 | 20 | 10 | 4 |
| Yellow | 10 | 10 | 1 | 0 |
| Black | 240 | 210 | 10 | 0 |

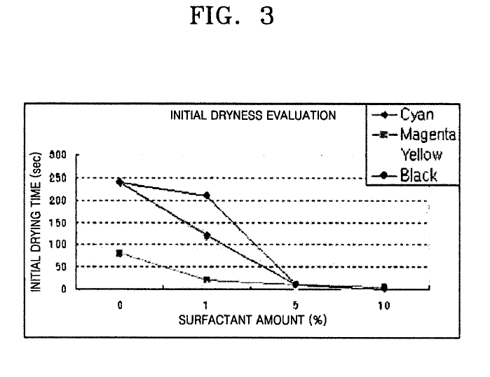

As can be seen from Table 4 and FIG. 3, illustrating the results of the initial dryness evaluation, as the amount of the surfactant used increased, the rate of nozzle clogging accelerated due to rapid drying of ink. As a result it was determined that a large amount of the surfactant used to adjust the surface tension of the ink may cause rapid drying.

Although a conventional surfactant decreases only surface tension, the surface property treatment agent in the ink composition herein has a high affinity to a hydrophobic colorant and can decrease the polarity of water to reduce the surface tension of the ink composition. The surface tension of the ink may be optimized by the delocalization of a lone pair of a hetero atom in an amide-based or ester-based compound of the surface property treatment agent, which allows a balance of the hydrophilic-hydrophobic properties of the ink. Thus, ink is stably present in an inkjet printer head and smoothly flows even when used for a long period, which facilitates the formation of ink droplets in the inkjet printer head and ejection thereof. Moreover, the surface property treatment agent interacts with an amine, imine, hydroxy, or acid group on the surface of paper to increase the penetration rate of the ink into the paper after printing, thereby reducing smearing due to slower penetration. Also, by using no surfactant or a minimal amount of a surfactant, the duration of storage stability may be increased.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An ink composition comprising a colorant, a solvent, and a surface property treatment agent represented by the following formula (1): 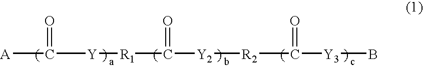
where each of Y₁, Y₂, and Y₃ is independently —N(R₃)— or —O—;
where R₃ is H, a C1-C20 alkyl group, or a C6-C20 aryl group;
each of R₁ and R₂ is independently a chemical bond, a C1-C10 alkylene group, a C2-C10 alkenylene group, a C2-C10 alkynylene group, or a C1-C20 alkyl group including a C2-C10 alkenylene group or a C2-C1O alkynylene group;
where 1≦a≦7, and b, c≧0 are integers;
each of A and B is a hydrophobic moiety independently selected from the group consisting of a substituted or unsubstituted C1-C12 alkyl group, a substituted or unsubstituted C2-C12 alkenyl group, a substituted or unsubstituted C2-C12 alkynyl group, and a substituted or unsubstituted C6-C12 aryl group, or are connected to each other to form a ring;
both A and B cannot be H; and
B can be a hetero atom.

2. The ink composition of claim 1, being a surfactant-free composition having a surface tension of 15-65 dyne/cm at 20° C., a viscosity of 1.0-10 cps, and an optical density after a smear test greater than 50% of the optical density of an original image on plain paper.

3. The ink composition of claim 1, wherein the surface property treatment agent is selected from the group consisting of compounds represented by formulae (4) through (11): 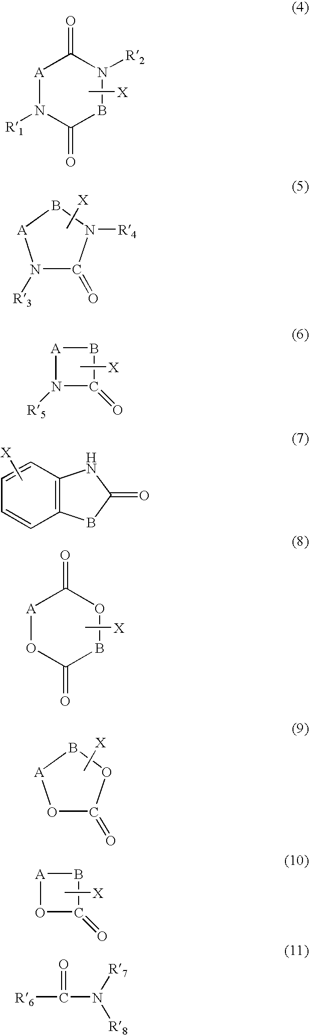
where each of R₁′, R₂′, R₃′, R₄′, R₅′, R₆′, R₇′, and R₈′ is independently H, a substituted or unsubstituted C1-C20 alkyl group, a substituted or unsubstituted C1-C20 heteroalkyl group, a substituted or unsubstituted C2-C20 alkenyl group, a substituted or unsubstituted C1-C20 alkoxy group, a substituted or unsubstituted C1-C20 alkylsulfoneamide group, a substituted or unsubstituted C6-C20 arylsulfoneamide group, a substituted or unsubstituted C1-C20 acylamino group, a C1-C20 alkylureido group, a C6-C20 arylureido group, a C2-C20 alkoxycarbonyl group, a C2-C20 alkoxycarbonylamino group, a carbamoyl group, a sulfamoyl group, a sulfo group and a salt thereof, a carboxy group and a salt thereof, a substituted or unsubstituted C1-C20 hydroxyalkyloxyalkyl group, a substituted or unsubstituted C1-C20 dialkylaminoalkyl group, a substituted or unsubstituted C6-C20 pyridylalkyl group, a substituted or unsubstituted C5-C20 pyridyl group, a substituted or unsubstituted C6-C20 imidazolyl group, a hydrazine group, a hydrazone group, a substituted or unsubstituted C1-C20 pyridylalkyl group, a substituted or unsubstituted C6-C20 aryl group, a substituted or unsubstituted C6-C20 arylalkyl group, a substituted or unsubstituted C6-C20 heteroaryl group, a substituted or unsubstituted C6-C20 heteroarylalkyl group, a substituted or unsubstituted C6-C20 heteroarylalkenyl group, a substituted or unsubstituted C3-C20 heteroarylaikenyl group, or a substituted or unsubstituted C3-C20 heterocycloalkyl group;
A is a simple chemical bond, —CH═CH—, or —CmH2m-;
B is a simple chemical bond, —CH═CH—, or —CnH2n-;
each of m and n is an integer from 0 to 10 and satisfies the following equation (1):
2≦m+n≦10 (1)
where if m=0, 2≦n≦10, and if n=0, 2≦m≦10; and
X is a monosubstituted or polysubstituted substituent and is H, a substituted or unsubstituted C1-C20 alkyl group, a substituted or unsubstituted C1-C20 heteroalkyl group, a substituted or unsubstituted C2-C20 alkenyl group, a substituted or unsubstituted C1-C20 alkoxy group, a substituted or unsubstituted C1-C20 alkylsulfoneamide group, a substituted or unsubstituted C6-C20 arylsulfoneamide group, a substituted or unsubstituted C1-C20 acylamino group, a C1-C20 alkylureido group, a C6-C20 arylureido group, a C2-C20 alkoxycarbonyl group, a C2-C20 alkoxycarbonylamino group, a carbamoyl group, a sulfamoyl group, a sulfo group and a salt thereof, a carboxy group and a salt thereof, a substituted or unsubstituted C1-C20 hydroxyalkyloxyalkyl group, a substituted or unsubstituted C1-C20 dialkylaminoalkyl group, a substituted or unsubstituted C6-C20 pyridylalkyl group, a substituted or unsubstituted C5-C20 pyridyl group, a substituted or unsubstituted C6-C20 imidazolyl group, hydrazine group, hydrazone group, a substituted or unsubstituted C1-C20 pyridylalkyl group, a substituted or unsubstituted C6-C20 aryl group, a substituted or unsubstituted C6-C20 arylalkyl group, a substituted or unsubstituted C6-C20 heteroaryl group, a C6-C20 heteroarylalkyl group, a substituted or unsubstituted C6-C20 heteroarylalkenyl group, or a substituted or unsubstituted C3-C20 heterocycloalkyl group.

4. The ink composition of claim 3, wherein R1′ and R2′ are each H or a methyl group and A and B are each —CH═CH—, —CH₂CH₂—, —CH₂—, or —CH(CH₃)—.

5. The ink composition of claim 1, wherein the compound represented by formula (1) is selected from the group consisting of compounds represented by the following formulae (12) to (22):

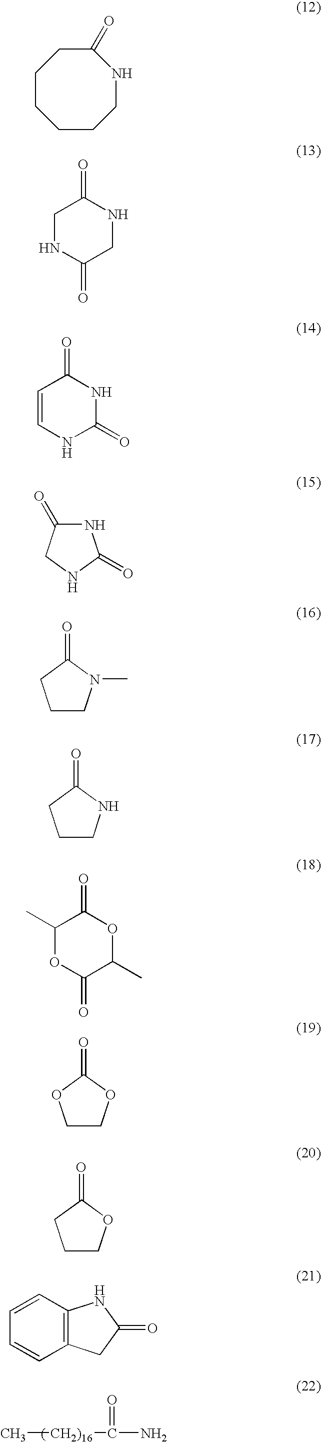

6. The ink composition of claim 1, wherein the amount of the surface property treatment agent represented by formula (1) is 0.01-20 parts by weight based on 100 parts by weight of the solvent.

7. The ink composition of claim 1, wherein the colorant is a dye or pigment.

8. The ink composition of claim 1, wherein the amount of the colorant is 0.5-10 parts by weight based on 100 parts by weight of the solvent.

9. The ink composition of claim 1, wherein the solvent is an aqueous liquid medium or a mixture of an aqueous liquid medium and an organic solvent.

10. The ink composition of claim 9, wherein the organic solvent includes at least one compound selected from the group consisting of methylalcohol, ethylalcohol, n-propylalcohol, isopropylalcohol, n-butylalcohol, sec-butylalcohol, t-butylalcohol, isobutylalcohol, acetone, methylethylketone, diacetonealcohol, ethyl acetate, ethyl lactate, ethyleneglycol, diethyleneglycol, triethyleneglycol, propyleneglycol, butyleneglycol, 1,4-butanediol, 1,2,4-butanetriol, 1,5-pentanediol, 1,2,6-hexanetriol, hexyleneglycol, glycerol, glycerol ethoxylate, trimethylolpropane ethoxylate, ethyleneglycol monomethyl ether, ethyleneglycol monoethyl ether, diethyleneglycol methyl ether, diethyleneglycol ethyl ether, triethyleneglycol monomethyl ether, triethyleneglycol monoethyl ether, dimethyl sulfoxide, tetramethylenesulfone, and thioglycol.

11. The ink composition of claim 1, wherein each of A and B may independently be a C1-C12 alkyl group, a C1-C12 heteroalkyl group, a C2-C12 alkenyl group, a C2-C12 heteroalkenyl group, a C2-C12 alkynyl group, a C6-C20 aryl group, a hydroxy group, a thiol group, a halogen atom, a nitro group, a cyano group, an isocyano group, an ester group, an amino group, a carboxylic group, or the like, but are not limited thereto. When A and B are connected to each other to form a ring, the ring may be a substituted or unsubstituted C4-C20 carbocycle, a substituted or unsubstituted C2-C20 heterocycle, or a C6-C20 aromatic ring

12. An ink composition comprising a colorant, a solvent, a surfactant, and a nonionic surface property treatment agent represented by the following formula (1): 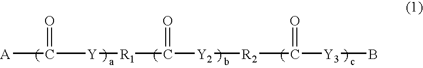
where each of Y₁, Y₂, and Y₃ is independently —N(R₃)— or —O—;
where R₃ is H, a C1-C20 alkyl group, or a C6-C20 aryl group;
each of R₁ and R₂ is independently a chemical bond, a C1-C10 alkylene group, a C2-C10 alkenylene group, a C2-C10 alkynylene group, or a C1-C20 alkyl group including a C2-C10 alkenylene group or a C2-C10alkynylene group;
where 1≦a≦7, and b, c≧0 are integers;
each of A and B is a hydrophobic moiety independently selected from the group consisting of a substituted or unsubstituted C1-C12 alkyl group, a substituted or unsubstituted C2-C12 alkenyl group, a substituted or unsubstituted C2-C12 alkynyl group, and a substituted or unsubstituted C6-C12 aryl group, or they are connected to each other to form a ring;
both A and B cannot be H; and
B can be a hetero atom.

13. The ink composition of claim 12, which has a surface tension of 15-65 dyne/cm at 20° C., a viscosity of 1.0-10 cps, and an optical density after a smear test greater than 50% of the optical of an original image on plain paper.

14. The ink composition of claim 12, wherein the nonionic surface property treatment agent is selected from the group consisting of compounds represented by formulae (4) through (11): 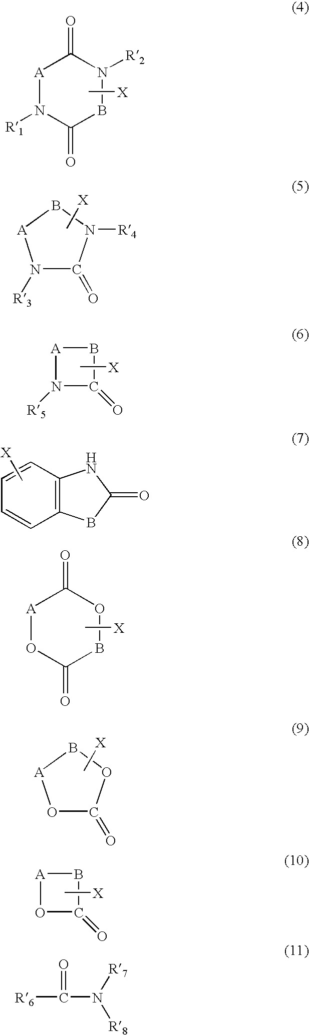
where each of R₁′, R₂′, R₃′, R₄′, R₅′, R₆′, R₇′, and R₈′ is independently H, a substituted or unsubstituted C1-C20 alkyl group, a substituted or unsubstituted C1-C20 heteroalkyl group, a substituted or unsubstituted C2-C20 alkenyl group, a substituted or unsubstituted C1-C20 alkoxy group, a substituted or unsubstituted C1-C20 alkylsulfoneamide group, a substituted or unsubstituted C6-C20 arylsulfoneamide group, a substituted or unsubstituted C1-C20 acylamino group, a C1-C20 alkylureido group, a C6-C20 arylureido group, a C2-C20 alkoxycarbonyl group, a C2-C20 alkoxycarbonylamino group, a carbamoyl group, a sulfamoyl group, a sulfo group and a salt thereof, a carboxy group and a salt thereof, a substituted or unsubstituted C1-C20 hydroxyalkyloxyalkyl group, a substituted or unsubstituted C1-C20 dialkylaminoalkyl group, a substituted or unsubstituted C6-C20 pyridylalkyl group, a substituted or unsubstituted C5-C20 pyridyl group, a substituted or unsubstituted C6-C20 imidazolyl group, a hydrazine group, a hydrazone group, a substituted or unsubstituted C1-C20 pyridylalkyl group, a substituted or unsubstituted C6-C20 aryl group, a substituted or unsubstituted C6-C20 arylalkyl group, a substituted or unsubstituted C6-C20 heteroaryl group, a substituted or unsubstituted C6-C20 heteroarylalkyl group, a substituted or unsubstituted C6-C20 heteroarylalkenyl group, a substituted or unsubstituted C3-C20 heteroarylalkenyl group, or a substituted or unsubstituted C3-C20 heterocycloalkyl group;
A is a simple chemical bond, —CH═CH—, or —CmH2m-;
B is a simple chemical bond, —CH═CH—, or —CnH2n-;
each of m and n is an integer from 0 to 10 and satisfies the following equation (1):
2≦m+n≦10 (1)
where if m=0, 2≦n≦10, and if n=0, 2≦m≦10; and
X is a monosubstituted or polysubstituted substituent and is H, a substituted or unsubstituted C1-C20 alkyl group, a substituted or unsubstituted C1-C20 heteroalkyl group, a substituted or unsubstituted C2-C20 alkenyl group, a substituted or unsubstituted C1-C20 alkoxy group, a substituted or unsubstituted C1-C20 alkylsulfoneamide group, a substituted or unsubstituted C6-C20 arylsulfoneamide group, a substituted or unsubstituted C1-C20 acylamino group, a C1-C20 alkylureido group, a C6-C20 arylureido group, a C2-C20 alkoxycarbonyl group, a C2-C20 alkoxycarbonylamino group, a carbamoyl group, a sulfamoyl group, a sulfo group and a salt thereof, a carboxy group and a salt thereof, a substituted or unsubstituted C1-C20 hydroxyalkyloxyalkyl group, a substituted or unsubstituted C1-C20 dialkylaminoalkyl group, a substituted or unsubstituted C6-C20 pyridylalkyl group, a substituted or unsubstituted C5-C20 pyridyl group, a substituted or unsubstituted C6-C20 imidazolyl group, hydrazine group, hydrazone group, a substituted or unsubstituted C1-C20 pyridylalkyl group, a substituted or unsubstituted C6-C20 aryl group, a substituted or unsubstituted C6-C20 arylalkyl group, a substituted or unsubstituted C6-C20 heteroaryl group, a C6-C20 heteroarylalkyl group, a substituted or unsubstituted C6-C20 heteroarylalkenyl group, or a substituted or unsubstituted C3-C20 heterocycloalkyl group.

15. The ink composition of claim 14, wherein R₁′ and R₂′ are each H or a methyl group and A and B are each —C≡C—, —CH═CH—, —CH₂CH₂—, —CH₂—, or —CH(CH₃)—.

16. The ink composition of claim 12, wherein the compound represented by formula (1) is selected from the group consisting of compounds represented by the following formulae (12) to (22):

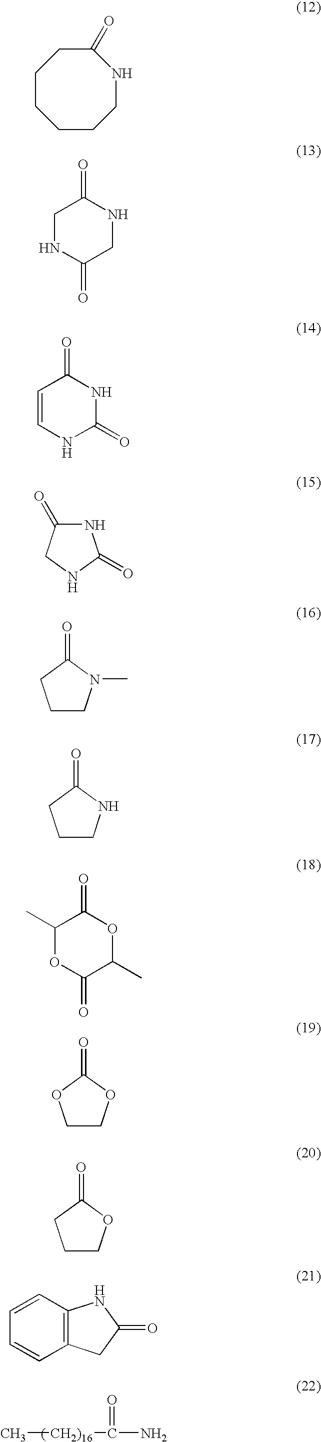

17. The ink composition of claim 12, wherein the amount of the nonionic surface property treatment agent represented by formula (1) is 0.01-20 parts by weight based on 100 parts by weight of the solvent.

18. The ink composition of claim 12, wherein the colorant is a dye or pigment.

19. The ink composition of claim 12, wherein the amount of the colorant is 0.5-10 parts by weight based on 100 parts by weight of the solvent.

20. The ink composition of claim 12, wherein the solvent is an aqueous liquid medium or a mixture of an aqueous liquid medium and an organic solvent.

21. The ink composition of claim 20, wherein the organic solvent includes at least one compound selected from the group consisting of methylalcohol, ethylalcohol, n-propylalcohol, isopropylalcohol, n-butylalcohol, sec-butylalcohol, t-butylalcohol, isobutylalcohol, acetone, methylethylketone, diacetonealcohol, ethyl acetate, ethyl lactate, ethyleneglycol, diethyleneglycol, triethyleneglycol, propyleneglycol, butyleneglycol, 1,4-butanediol, 1,2,4-butanetriol, 1,5-pentanediol, 1,2,6-hexanetriol, hexyleneglycol, glycerol, glycerol ethoxylate, trimethylolpropane ethoxylate, ethyleneglycol monomethyl ether, ethyleneglycol monoethyl ether, diethyleneglycol methyl ether, diethyleneglycol ethyl ether, triethyleneglycol monomethyl ether, triethyleneglycol monoethyl ether, dimethyl sulfoxide, tetramethylenesulfone, and thioglycol.

22. The ink composition of claim 12, wherein the surfactant includes at least one surfactant selected from the group consisting of ionic surfactants and non-ionic surfactants.

23. The ink composition of claim 12, wherein the amount of the surfactant is 0.005-3.0 parts by weight based on 100 parts by weight of the solvent.

24. An ink having a surfactant-free composition including a colorant, a solvent, and a surface property treatment agent, the ink composition comprising:
0.01-20 parts by weight of the surface property treatment agent based on 100 parts by weight of the solvent and the colorant;
0.5-10 parts by weight of the colorant based on 100 parts by weight of the solvent and the surface property agent;
40-95 parts by weight of the solvent based on 100 parts by weight of the colorant and the surface property treatment agent.

25. The ink composition of claim 24, wherein the ink composition has a surface tension of 20-65 dyne/cm at 20° C.

26. The ink composition of claim 24, further comprising:
0.1-20 parts of an acid or base by weight based on 100 parts by weight of the solvent.

27. The ink composition of claim 24, wherein the ink composition has a viscosity of 1-10 cps.

28. The ink composition of claim 24, wherein the colorant is a dye or pigment.

29. The ink composition of claim 25, wherein the solvent is composed of an aqueous liquid medium or a mixture of an aqueous liquid medium and an organic solvent.

30. A method of preparing an ink composition comprising:
combining a colorant, a surface property treatment agent, and a solvent, wherein the surface property treatment agent represents 0.01-20 parts by weight based on 100 parts by weight of the solvent and the colorant, the colorant represents 0.5-10 parts by weight based on 100 parts by weight of the solvent and the surface property agent, and the solvent represents 40-95 parts by weight based on 100 parts by weight of both the colorant and the surface property treatment agent;
mixing the combination; and
filtering the combination to obtain the ink composition.
